(19) United States
(12) Patent Application Publication
(10) Pub. No.: US 2005/0229113 A1
(43) Pub. Date: Oct. 13, 2005

(54) Highlighted objects window

(75) Inventors: Terrence Martineau, Ottawa (CA); David Kiesekamp, Ottawa (CA); Denis Armand Proulx, Kanata (CA); Suyan Shao, Ottawa (CA); Satvinder Singh Bawa, Ottawa (CA); Raymond Canton, Ottawa (CA)

Correspondence Address: KRAMER & AMADO, P.C., Suite 240, 1725 Duke Street, Alexandria, VA, 22314, US

(73) Assignee: ALCATEL, Paris (FR)

(21) Appl. No.: 10/820,827

(22) Filed: Apr. 9, 2004

(51) Int. Cl. G06F 3/00

(52) U.S. Cl. 715/822; 715/712; 715/713; 715/739; 715/810

(57) ABSTRACT

For displaying information on all highlighted objects in a hierarchical chain of objects, a graphical user interface (GUI), identifies an original highlighted object displayed on a window at a selected hierarchically level. The highlighted object(s) subtended by the original object at the hierarchically next lower level is/are identified and selected from an object storage means, etc, until all highlighted objects corresponding to the original object are identified and selected. The selected objects are placed in a list, and the GIU displays the list in a highlighted objects window where the objects are arranged in a specified order. The list comprises a row for each highlighted object, and a plurality of columns, each column for providing a specified attribute of the object. The GUI may then selects order of the objects in the window by sorting the list by any of the columns.

### FIELD OF THE INVENTION

The invention is directed to management of communication networks and in particular to a highlighted object window for a network management graphical user interface.

### BACKGROUND OF THE INVENTION

Due to recent explosive technological development and the ensuing growing size of the communication networks, the network management became a very complex task. Numerous factors contribute to this growing complexity. For example, modern communication networks use heterogeneous equipment provided by different vendors and/or use a multitude of data communication technologies and protocols, a multitude of network management and service provisioning protocols, etc. In addition, the topology of the network is changing at a fast pace. Not only new network elements (NE) are added, removed, moved or replaced with newer versions, but they are also more geographically dispersed. In many cases, the customers wish to divide their network into different regions based on political or business boundaries; quite frequently two or more regions overlap, presenting a challenge given the current engineering limits. All these changes cause significant technological challenges to the nature of network management.

In a network management system, each managed node is defined by a plurality of “variables”. A management station or the operator can monitor the nodes by examining (reading) the values of these variables, and can control the nodes by remotely changing (writing) the values of these variables. Network information is usually presented in the form of network maps which show graphic symbols (icons) of the NEs on a video display screen of a video display terminal on a workstation. This is called a graphical user interface, or GUI. Each window of the GUI provides the user with the ability to manipulate the information of interest utilizing a mouse, or the like. This user action causes the GUI to process the request by performing the respective action or displaying a map of another hierarchical level.

It is important that the information displayed by the GUI clearly identifies the network entities for which information is being presented. It is also important for the GUI to provide the user with the ability to select additional information about a particular network entity and to present the information in a clear and well organized display. Finally, displays of network information should be flexible to accommodate differing network configurations and differing network management requirements.

The networks dynamics causes significant technological challenges to the way in which information is presented to a user. As generally the scale of a communications network is too large and too complex to display all objects of the respective network in a single network map window, the network is divided into hierarchical layers of network object groups, which are shown in separate windows, ranging from upper layer maps of hundreds of network nodes, to lower layer maps of network elements at a certain selected node. This same information can also be represented in a complex tree of objects.

As the number of network layers increases, it becomes a time consuming job for the user to search through many windows since this involves clicking symbols in a window to open the respective sub-layer map and then clicking on the respective sub-layer map symbols, etc. The complexity of finding the correct object in a tree view representation is equally high. In many cases, this operation could also fail, as it is not easy to follow correctly the hierarchical layers conducting to the desired end result. In practice, a customer evaluates the efficiency of a GUI in terms of the number of mouse clicks it takes an operator to perform a certain function.

Some network managers (such as Alcatel's 5620 NM) enable customers to highlight objects displayed on a map or a list. The highlighting changes the background color of an object(s), and is used to trace a specific object through a managed system. However, the operator needs to trace an object through different layers of the object hierarchy, so that after performing the highlight function, the operator would still have to navigate through each layer of the hierarchy, one layer at a time.

Although an attempt to drastically reduce the number of hierarchical layers is impractical because it necessitates overall reconfiguration of the network object containment, it is the usual practice to merge two or more windows by transferring symbols from a lower layer to an upper layer. However, deletion and re-registration of the transferred symbols are necessary. In addition, current network display systems do not allow lower layer maps to be displayed within an upper layer window.

There is a need to provide a faster, automated way to obtain information on a highlighted chain of objects in a network.

### SUMMARY OF THE INVENTION

It is an object of the present invention to provide a GUI of a communication network with a highlighted objects window that enables fast access through many layers of hierarchical objects of a network.

The invention provides a method of displaying highlighted objects information on a graphical user interface (GUI) comprising: a) highlighting a primary object O(n) displayed on a GUI window at a selected hierarchically level (n); b) identifying a highlighted object O(n-1) subtended by the primary object at a hierarchically next lower level (n-1); c) selecting the highlighted object O(n-1) from an object storage means and placing same in a list of highlighted objects; and d) repeating steps b) and c) for all n available hierarchical levels until all highlighted objects corresponding to the primary object are identified and placed in said list.

According to a further aspect, the invention further provides a highlighted objects window system for a graphical user interface (GUI) of the type provided with highlighting capabilities and adapted to transmit commands and display information with a view to enable management of a communication network. The system comprises means for identifying all highlighted objects in a highlighted hierarchy corresponding to a primary object highlighted on the GUI; and means for selecting only the highlighted objects from an object storage means and placing the objects in a list, the GUI display ing the list in a highlighted objects window where the highlighted objects are arranged in a specified order.

Still further, the invention provides a method of using a graphical user interface (GUI) of the type provided with highlighting capabilities and adapted to transmit commands and display information with a view to enable management of a communication network, comprising: a) highlighting an original object on a topological map at a selected hierarchically level; b) identifying all highlighted objects corresponding to the original object in all hierarchical levels subtended from the selected hierarchically level; c) selecting all the highlighted objects from an object storage means and placing same in a list in their hierarchical order of identification; and d) displaying the list as a highlighted objects window for obtaining information of interest about the primary object.

Advantageously, use of the highlighted objects window according to the invention, results in important reduction of the amount of time it takes a user to navigate through the chain of hierarchical objects to obtain the relevant information for the managed objects of interest. In other words, the present solution results in a reduced number of “point and click” operations required for obtaining the information of interest.

Still another advantage of the invention resides in the ability of the GUI to display the list of objects in the highlight hierarchy, as well as additional information relevant to each object, such as the object type, status, specification, name, etc.

### BRIEF DESCRIPTION OF THE DRAWINGS

The foregoing and other objects, features and advantages of the invention will be apparent from the following more particular description of the preferred embodiments, as illustrated in the appended drawings, where:

FIG. 1 shows an example of a network map with a highlighted object;

FIG. 2 shows the highlighted objects window corresponding to the example of FIG. 1;

FIG. 3a is a block diagram of the units that enable generation of the highlighted object window according to the invention; and

FIG. 3b illustrates how a highlighted objects window list is generated for the example of FIGS. 1 and 2.

### DETAILED DESCRIPTION

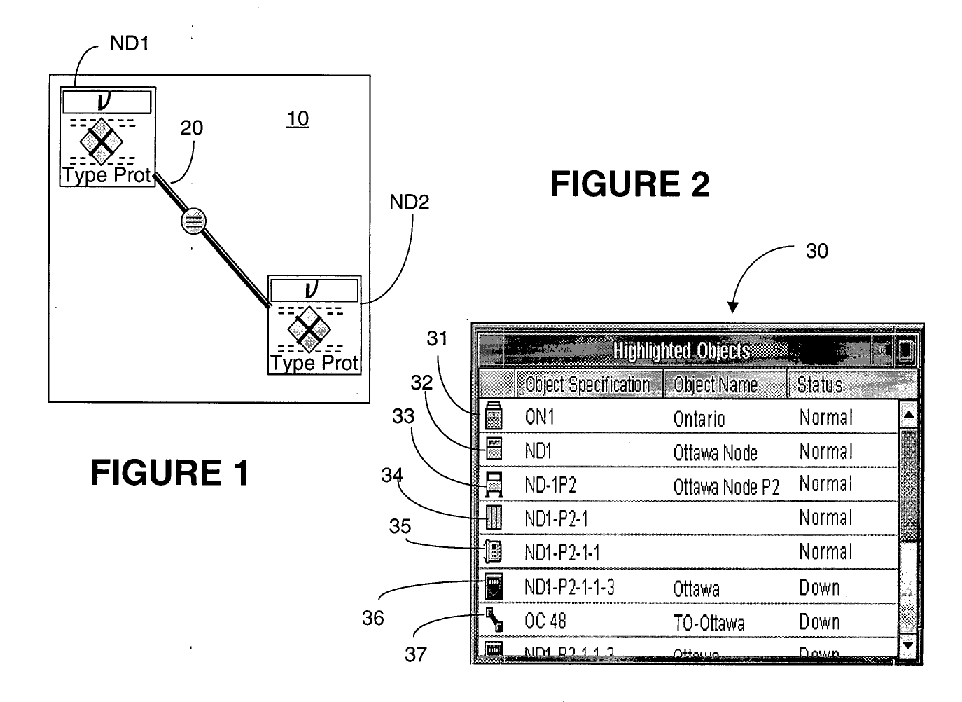

FIG. 1 shows an example of a very simple network management map 10, illustrating a first node ND1, housing a first network device, a second node ND2, housing a second network device, and a link 20 between the two network devices. Let's assume that the operator wishes to find the ports on the respective devices that are the ends of link 20. According to the invention, the operator only has to click and highlight link 20 to obtain a list of all objects involved in this connection.

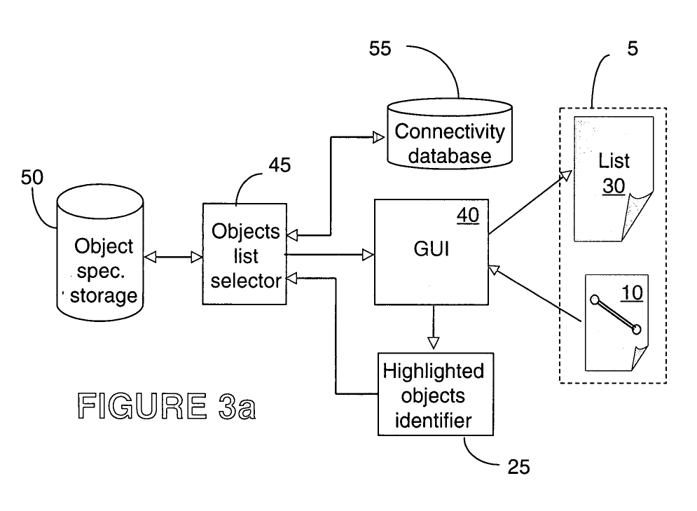

FIG. 2 shows a highlighted objects window 30 for the example of FIG. 1, which displays a list 30′ of the objects in the highlight heirarchy. This example has been simplified for clarity, as normally a link will have multiple nodes along the way, each with the respecive shelves, slots, cards, ports, etc. Also, each node could be in a group that could be inside another group, inside another group, etc. In this simplified example, window 30 displays a list 30′ showing the group the nodes ND1 and ND2 reside in (ON1 in this example), the first node ND1 and the first network device ND-1P2 at node ND1. The icons of the respective network elements such as group icon 31, node icon 32 and network device icon 33 are provided in this example in the first column, and the object specification (node identification) in the second column. The object names are also specified in list 30′. In this example, the network device ND-1P2 resides in an “Ontario Group”, at an “Ottawa Node” and is called “Ottawa Node P2”.

The next rows show the objects contained in first network device from the top to bottom of the hierarchy. In this example they are shelf ND1-P2-1 identified by icon 34, card ND1-P2-1-1 identified by icon 35 and port ND1-P2-1-1-3 identified by icon 36. For a general case, if we denote the hierarchical level of the map of interest (highest level, original map 10) with n and the objects highlighted on this map with O(n), the lower hierarchy objects are denoted with O(n-1), O(n-2) and O(n-3), while the respective levels are denoted with (n-1), (n-2) and respectively (n-3).

Link 20 is listed next, and is shown using icon 37. The object specification for this highlighted object indicates the bandwidth of the link “OC48” and the object name gives in this example the direction “Toronto-Ottawa” for the connection over this link.

The next rows (not shown) list the highlighted objects at the second node ND2, namely the objects relevant to the connection over link 20 at a second network device ND-2P2. These are preferably shown hierarchically from bottom to the top so that the end ports of the link 20 appear in the list above and below the row with the link object. Let's assume that these are port ND2-P2-1-1-1, card ND2-P2-1-2, shelf ND2-P2-1. Toronto end network device ND2-P2, and node ND2 end the list of highlighted objects. If ND2 belongs to a node group, this is also shown in list 30′.

Icons 31-37 in the leftmost column quickly identify the object type and status. The colour of the icon indicates its status, therefore locating an alarmed object (e.g. coloured red) in the list is fast.

Additional columns, such as a status column shown in FIG. 2, may also be provided depending on the level of information available at the resepective node. Still further, list 30′ may include a column with the count of all the objects in the highlighted hierarchy. As all the managed objects of the hierarchically lower layers are shown on the list, the amount of time it takes a user to navigate through the highlight chain and evaluate each iobject is greatly reduced. In addition, GUI 40 enables the operator to select objects in the list 30′ for viewing further details if necessary and available.

List 30′ can be sorted by the highlight hierarchy or by any of the displayed columns. Window 30 may also be provided with a refresh button (not shown) for enabling the operator to update list 30′ of highlighted objects. Double clicking on a row (line) item in the list provides access to that item.

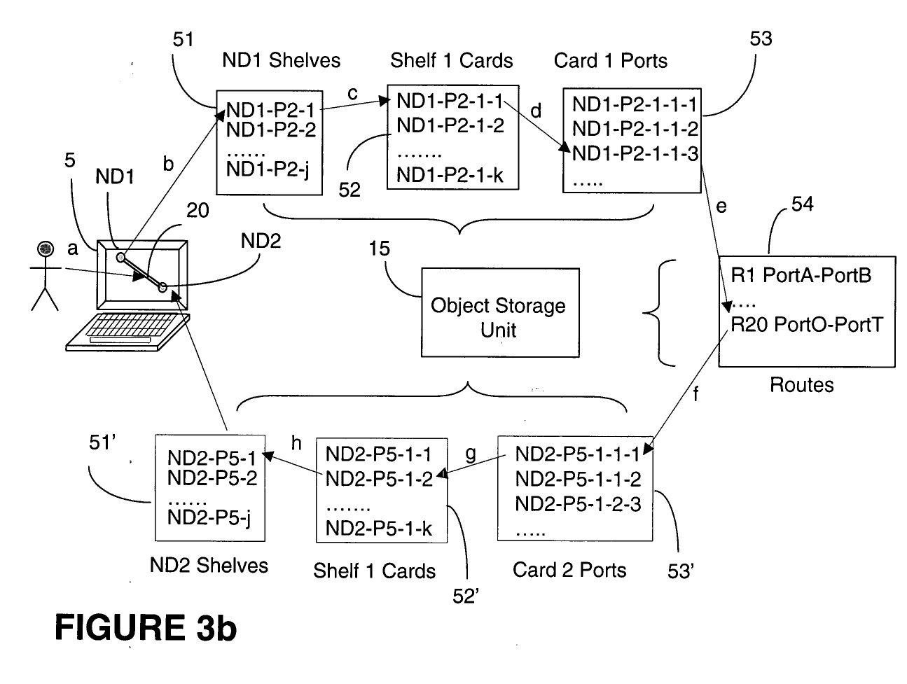

FIG. 3a show a high-level block diagram of the main units involved in generating the highlighted objects window according to the invention. It is to be noted that this figure illustrates only the units at the node relevant to this invention, for simplicity. GUI 40 performs conventional user interface functions enabling an operator to monitor and manage the network as well known. For the example used in this specification, GUI 40 provides an operator with a map (or tree) of interest, here map 10, that is displayed on the screen of workstation 5, as well known. In addition, GUI 40 enables the operator to highlight objects displayed in the window. In this example, the operator clicks on link 20 to highlight it.

The object highlighted on map 10, here link 20, and all objects of interest subtended by this primary highlighted object are identified by identifier block 25 based on the GUI 40 object highlight capability. An object list selector 45 accesses the respective objects and object specification information relevant to all the objects identified by unit 25. Once the information pertinent to the highlighted objects is collected, GUI 40 generates list 30′ that is displayed on the screen 5.

It is to be mentioned that the location or the way the object specification information is stored at the node is not relevant to the invention; relevant is only availability of this information. In general, all nodes maintain an object library 50 that comprises data pertinent to all network elements at the respective node, available for use by various network management applications. The place where object data is stored is called herein generically “object specification storage” and is denoted with 50. The information about the ports used by a specified connection is also available at the node, shown generically in FIG. 3a by connectivity database 55; if this information is not readily available, it may be imported from the routing database.

FIG. 3b shows how list 30′ of highlighted objects is generated for the example of FIGS. 1 and 2. It is to be noted that this Figure does not illustrate the objects at the device, node and node group level for simplification. To reiterate, the highlighted objects window 30 provides a list of all the objects that are highlighted in a certain window presented by the GUI, from all the layers of the object hierarchy. The objects are arranged in the list in a specified order, as described above.

First, the operator clicks on link 20 to highlight it, as shown by arrow a. The highlighted objects identifier 25 (see FIG. 3a) identifies the objects on map 10 pertinent to the operator's request. Then, the object list selector 45 (see FIG. 3a) collects hierarchically the highlighted object data from the object storage 15 that includes generically the pertinent databases with the objects specifications and connectivity data, by first locating the highlighted node group, node and network device information and placing it in list 30′ (not shown).

Next, the highlighted shelf ND1-P2-1 is identified in shelf domain 51 corresponding to the first network device, as shown by arrow b. Shelf ND1-P2-1 is placed in list 30′ together with the relevant information in the respective columns. Then, objects list selector 45 searches domain 52 of cards subtended by this shelf to locate the highlighted card ND1-P2-1-1, as shown by arrow c. Card ND1-P2-1-1 and the relevant information are now placed in the next row of the list 30′, and the respective columns of the list are completed with the relevant information. Arrow d shows how the port information is located by searching the domain 53 of ports available on card ND1-P2-1-1. The object selector identifies highlighted port ND1-P2-1-1-3 and places it in list 30′.

Link 20 data is searched next, arrow e, in routing domain 54 as it provides the connection between the port-3/card-1/shelf-1/node-P2/ND1 and port-1 at the Toronto end. This information is also provided to the GUI for insertion in list 30′.

Next, highlighted objects identifier 25 identifies the objects at the second end of link 20 for completing list 30′. As described above, the respective object storage unit 15 at the second node maintains the data pertinent to network device ND2-P5 at the Toronto node ND2. For this example, these are port ND2-P5-1-1-1 in domain 53′ with the ports of card ND2-P5-1-2, card ND2-P5-1-2 from the domain 52′ with the cards of shelf ND2-P5-1 and shelf ND2-P5-1 from the domain 51′ with the shelves of the second network device ND2. The last items on list 30′ are the second network device ND-2P2 and the second node ND2. As before, arrows f, g, h and i indicate how the collection of the data proceeds at network device ND2.

1. A method of displaying highlighted objects information on a graphical user interface (GUI), comprising:
a) highlighting a primary object O(n) displayed on a GUI window at a selected hierarchically level (n);
b) identifying a highlighted object O(n-1) subtended by said primary object at a hierarchically next lower level (n-1);
c) selecting said highlighted object O(n-1) from an object storage means and placing same in a list of highlighted objects; and
d) repeating steps b) and c) for all n available hierarchical levels until all highlighted objects corresponding to said primary object are identified and placed in said list.

2. The method of claim 1 further comprising: e) displaying said list in a highlighted objects window where said highlighted objects are arranged in a specified order.

3. The method of claim 2, wherein said specified order is the hierarchical order of said highlighted objects.

4. The method of claim 1, wherein said list comprises a row for each highlighted object, and a plurality of columns, each column for providing a specified attribute of said highlighted object.

5. The method of claim 4, wherein said specified attributes are the specification of said highlighted object and the name of said highlighted object.

6. The method of claim 2, wherein said highlighted objects window displays a column for an icon visually identifying said highlighted object.

7. The method of claim 2, wherein said highlighted objects window displays an object status column for defining the current status of said highlighted object.

8. The system of claim 2, wherein said highlighted objects window displays a count column for counting the number of said highlighted objects in said list.

9. The system of claim 4, wherein said GUI selects said specified order by sorting the objects in said list by any of said columns.

10. A highlighted objects window system for a graphical user interface (GUI) of the type provided with highlighting capabilities and adapted to transmit commands and display information with a view to enable management of a communication network, said system comprising:
means for identifying all highlighted objects in a highlighted hierarchy corresponding to a primary object highlighted on said GUI; and
means for selecting only said highlighted objects from an object storage means and placing said objects in a list,
wherein said GUI displays said list in a highlighted objects window where said highlighted objects are arranged in a specified order.

11. The system of claim 10, wherein said list comprises a row for each highlighted object, and a plurality of columns, each column for providing a specific attribute of said highlighted object.

12. The system of claim 10, wherein said GUI selects said specified order by sorting said list by any of said columns.

13. The system of claim 12, wherein said list includes a column for an icon visually identifying said highlighted object, a column with the specification of said highlighted object and a column with the name of said highlighted object.

14. The system of claim 13, wherein said list further comprises an object status column for defining the current status of said highlighted objects.

15. The system of claim 13, wherein said list further comprises a count column for counting the number of said highlighted objects in said list.

16. The system of claim 10, wherein said object storage means comprises an object library for maintaining data pertinent to all objects present at a respective network node.

17. The system of claim 10, wherein said object storage means comprises a connectivity database for maintaining routing data pertinent to all routes currently involving a respective network node.

18. The system of claim 10, wherein said highlighted objects window comprises a refresh button for updating said list.

19. A method of using a graphical user interface (GUI) of the type provided with highlighting capabilities and adapted to transmit commands and display information with a view to enable management of a communication network, comprising:
a) highlighting an original object on a GUI window displaying managed objects at a selected hierarchically level;
b) identifying all highlighted objects corresponding to said original object in all hierarchical levels subtended from said selected hierarchically level;
c) selecting all said highlighted objects from an object storage means and placing same in a list in a specified order; and
d) displaying said list as a highlighted objects window for providing an automatic way to obtain information on a hierarchical chain of objects in said network.

20. The method of claim 19, wherein said specified order is the hierarchical order of the objects.
